(19) United States
(12) Patent Application Publication
(10) Pub. No.: US 2009/0019237 A1
(43) Pub. Date: Jan. 15, 2009

(54) MULTIPATH ACCESSIBLE SEMICONDUCTOR MEMORY DEVICE HAVING CONTINUOUS ADDRESS MAP AND METHOD OF PROVIDING THE SAME

(75) Inventors: Jin-Hyoung Kwon, Seongnam-si (KR); Han-Gu Sohn, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/139,622

(22) Filed: Jun. 16, 2008

(30) Foreign Application Priority Data
Jul. 10, 2007 (KR) 10-2007-0069095

(51) Int. Cl. G06F 12/02

(52) U.S. Cl. 711/148; 711/E12.008; 711/E12.002

(57) ABSTRACT

A semiconductor memory device for use in a multiprocessor system includes at least two shared memory areas and a row decoder. The at least two shared memory areas are accessible in common by multiple processors of the multiprocessor system through different ports, and assigned based on predetermined memory capacity to a portion of a memory cell array. The row decoder is configured to form a continuous address map for remaining memory portions of the at least two shared memory areas to be dedicated to one port. Each remaining memory portion does not include a corresponding data transfer portion within each shared memory area.

### CROSS REFERENCE TO RELATED APPLICATIONS

A claim of priority is made to Korean Patent Application No. 10-2007-0069095, filed on Jul. 10, 2007, the subject matter of which is hereby incorporated by reference.

### BACKGROUND AND SUMMARY

1. Technical Field

The present invention relates to semiconductor memory devices, and more particularly, to a semiconductor memory device accessing shared memory areas through multiple paths.

2. Description of Related Art

In general, a semiconductor memory device having multiple access ports is called a multiport memory. More particularly, a memory device having two access ports is called a dual-port memory. A typical dual-port memory may be an image processing video memory having a random access memory (RAM) port accessible in a random sequence and a serial access memory (SAM) port accessible only in a serial sequence.

A multipath accessible semiconductor memory device is distinguishable from a multiport memory. Unlike the configuration of the video memory, a multipath accessible semiconductor memory device includes a dynamic random access memory (DRAM), which has a shared memory area accessible by respective processors through multiple access ports. A memory cell array of the device does not have a SAM port, but is constructed of a DRAM cell.

Universally, remarkable developments are being made in consumer electronic systems. For example, in recent mobile communication systems, such as handheld multimedia players, handheld phones, PDAs, etc., manufacturers are producing products having multiprocessor systems, which incorporate processors adapted in one system to obtain higher speeds and smoother operations.

An example of a conventional memory adequate for a multiprocessor system is disclosed by MATTER et al. (U.S. Patent Application Publication No. 2003/0093628), published May 15, 2003. MATTER et al. generally discloses technology for accessing a shared memory area by multiple processors, in which a memory array includes first, second and third portions. The first portion of the memory array is accessed only by a first processor, the second portion is accessed only by a second processor, and the third portion is a shared memory area accessed by both the first and second processors.

In contrast, in a general multiprocessor system, a nonvolatile memory that stores processor boot codes, e.g., a flash memory, is adapted each to a processor. A DRAM is also adapted as a volatile memory for every corresponding processor. That is, the DRAM and the flash memory are each adapted to one processor. The configuration of the processor system is therefore complicated and costly.

Therefore, a multiprocessor system adaptable to a mobile communication device was developed, as shown in FIG. 1. More particularly, FIG. 1 is a schematic block diagram of a conventional multiprocessor system having a multipath accessible DRAM.

As shown in FIG. 1, in a multiprocessor system, including two or more processors 100 and 200, DRAM 400 and flash memory 300 are shared. Also, a data interface between the processors 100 and 200 is obtained through the multipath accessible DRAM 400. In FIG. 1, the first processor 100, which is not directly connected to the flash memory 300, may indirectly access the flash memory 300 through the multipath accessible DRAM 400. The second processor 200 accesses the flash memory 300 through bus B3.

The first processor 100 may be a baseband processor function for performing a determined task, e.g., modulation and demodulation of a communication signal, and the second processor 200 may have an application processor function for performing user applications, such as data communications, electronic games or amusement, etc., or vice versa in other cases for function of the processors.

The flash memory 300 may be a NOR flash memory having a NOR structure for a cell array configuration, or a NAND flash memory having a NAND structure for a cell array configuration. The NOR flash memory or the NAND flash memory is a nonvolatile memory for which memory cells, e.g., constructed of MOS transistors having floating gates, are formed in an array. Such nonvolatile memory stores data that is not deleted, even when power is turned off, such as boot codes of handheld instruments, preservation data, and the like.

In addition, the multipath accessible DRAM 400 functions as a main memory for a data process of the processors 100 and 200. The multipath accessible DRAM 400 shown in FIG. 1 is similar in functionality to a DRAM type memory known as OneDRAM™, provided by Samsung Electronics Co., Ltd. As shown in FIG. 1, first and second ports 60 and 61, respectively connected to corresponding system buses B1 and B2, are inside the multipath accessible DRAM 400, so that the multipath accessible DRAM 400 may be accessed by the first and second processors 100 and 200 through two different ports, as shown in FIG. 2. The multiple port configuration differs from a general DRAM configuration having a single port.

FIG. 2 is a block diagram of a circuit that provides operating characteristics of the multipath accessible DRAM 400, e.g., OneDRAM™, shown in FIG. 1.

Referring to FIG. 2, in the multipath accessible DRAM 400, four memory areas 10, 11, 12 and 13 constitute a memory cell array. For example, memory area 10 (bank A) may be accessed dedicatedly by first processor 100 through the first port 60, and memory areas 12 and 13 (banks C and D) may be accessed dedicatedly by the second processor 200 through second port 61. The memory area 11 (bank B) may be accessed by both the first and second processors 100 and 200 through the first and second ports 60, 61, respectively. As a result, in the memory cell array, memory area 11 (bank B) is assigned as a shared memory area, and memory areas 10, 12 and 13 (banks A, C and D) are assigned as dedicated memory areas, each of which is accessed by only one of the corresponding processors. The four memory areas 10-13 (banks A-D) may be constructed as a bank unit of the DRAM 400. Each bank may have memory storage of 64 Mb, 128 Mb, 256 Mb, 512 Mb or 1024 Mb, for example.

In FIG. 2, internal register 50 functions as an interface between the first and second processors 100 and 200, and is thus accessible by the first and second processors 100 and 200. The internal register 50 may be a flip-flop, data latch or static random access memory (SRAM) cell, for example. The internal register 50 may include a semaphore area 51, a first mailbox area 52 (e.g., mail box A to B), a second mailbox area 53 (e.g., mail box B to A), a check bit area 54, and reserve area 55. The areas 51-55 may be enabled in common by a specific row address, and accessed individually by an applied column address. For example, when row address 1FFF800h˜1FFFFFFh indicating a specific row area 121 of the shared memory area 11, is applied, a portion area 121 of the shared memory area 11 is disabled, and the internal register 50 is enabled.

As would be appreciated by one of ordinary skill in the relevant art, a control authority for the shared memory area 11 is written in the semaphore area 51. Also, a message, e.g., authority request, transmission data such as logical/physical address of flash memory or data size or address of shared memory to store data, or commands, etc., given to a counterpart processor authority request, is written in the first and second mailbox areas 52 and 53, according to a predetermined transmission direction.

A control unit 30 controls a path to operationally connect the shared memory area 11 to one of the first and second processors 100 and 200. A signal line R1, connected between the first port 60 and the control unit 30, transfers a first external signal applied through bus B1 from the first processor 100. A signal line R2, connected between the second port 61 and the control unit 30, transfers a second external signal applied through bus B2 from the second processor 200. The first and second external signals may include a row address strobe signal RASB, write enable signal WEB and bank selection address BA, e.g., separately applied through the first and second ports 60 and 61. Signal lines C1 and C2, connected between the control unit 30 and each multiplexer 46, 41, operationally connect the shared memory area 11 to the first or second port 60, 61.

FIG. 3 conceptually illustrates an address assignment to access memory banks and the internal register 50 of FIG. 2. For example, when each memory area 10-13 (banks A-D) has a capacity of 16 mega bits, 2 KB of the shared memory area 11 (bank B) is determined to be a disabled area. That is, a specific row address (e.g., 1FFF800h˜1FFFFFFh, 2 KB size=1 row size), enabling one optional row of the shared memory area 11 within the DRAM, is changeably assigned to the internal register 50 as the interface unit. Then, when the specific row address (1FFF800h˜1FFFFFFh) is applied, a corresponding specific word line 121 of the shared memory area 11 is disabled, but the register 50 is enabled.

As a result, in an aspect of the system, the semaphore area 51 and the mailbox areas 52 and 53 are accessed using a direct address mapping method. Internal to the DRAM, a command to a corresponding disabled address is decoded, and mapping to an interior register of the DRAM is performed. Thus, a memory controller of the chip set produces a command for this area through the same method as other memory cells. In FIG. 3, the semaphore area 51, the first mailbox area 52 and the second mailbox area 53 may be each have 16 bits, and the check bit area 54 may have 4 bits, for example.

When the multiprocessor system of FIG. 1 includes a DRAM 400 (e.g. OneDRAM™) having a shared memory area as described above referring to FIGS. 2 and 3, the DRAM 400 and the flash memory 300 are used in common without having to be assigned to every processor. Thus, the complexity and the size of system can be reduced, as well as the number of memories.

As mentioned above, the multipath accessible DRAM 400 shown in FIG. 1 is similar in functionality to a DRAM type memory known as OneDRAM™, provided by Samsung Electronics Co. Ltd. OneDRAM™ is a fusion memory chip that increases data processing speed between a communication processor and a media processor in a mobile device. In general, two processors require two memory buffers. However, the OneDRAM™ solution can route data between processors through a single chip, so two memory buffers are not required. OneDRAM™ reduces data transmission time between processors by employing a dual-port approach. A single OneDRAM™ module can replace at least two mobile memory chips, e.g., within a high-performance smart-phone or other multimedia rich-handset. As data processing speed between processors increases, OneDRAM™ reduces the number of chips, reduces power consumption by about 30 percent and reduces total die area coverage by about 50 percent. As a result, cellular phone speed may increase five times, battery life may be prolonged, and handset design may be slimmer, for example.

In the multiprocessor system of FIG. 1, sharing a multipath accessible DRAM, such as oneDRAM™, etc., and a flash memory, multiple shared memory areas may be employed in addition to the one shared memory area. That is, unlike the one shared bank (i.e., memory area 11), shown in FIG. 2 for extending memory capacity, two or more banks may be designed shared memory areas. However, when sharing multiple memory areas, remaining portions of the memory areas, which are portions of the memory areas other than data transfer portions, are dedicated to any one port, resulting in use limitations, as indicated in FIG. 4.

FIG. 4 conceptually illustrates an area showing use limitations of a conventional memory use extension for one port in a multi-shared memory bank structure.

Referring to FIG. 4, a memory cell array may include eight banks, for example, memory area 2 (bank A) to memory area 16 (bank H). Among the multiple banks, memory area 2 (bank A) and memory area 4 (bank B) are shared memory areas, individually accessible in common by multiple processors. Memory area 6 (bank C) to memory area 16 (bank H) are dedicated memory areas, accessible by only one predetermined processor of the multiple processors. For example, the dedicated memory areas 6 to 16 may be accessed only by the second processor 200 through port 61 (port B), corresponding to the second port of FIG. 2. The memory areas 2 and 4 are accessible in common by the first and second processors 100 and 200 through port 60 (port A), corresponding to the first port of FIG. 2, as well as port 61. However, in assigning remaining portions 402 and 404 within the memory areas 2 and 4 (banks A and B), i.e., those portions of memory areas 2 and 4 other than data transfer portions 403 and 405, to be used exclusively by the first processor 100, for example, it is difficult to control a memory management unit (not shown) of the processor due to discontinuity of the memory map.

For example, when the first processor 100 uses memory area 2 (bank A) and memory area 4 (bank B), the first processor 100 cannot actually use a remaining portion 404 of the memory area 4, indicated by lines within the memory area 4. This remaining portion 404 of memory area 4 includes the portion of memory area 4 other than the data transfer portion 405 of memory area 4. A data transfer portion 403 of memory area 2 is positioned between a remaining portion 402 of the memory area 2 and the remaining portion 404 of memory area 4. Accordingly, there is no continuity of the address map. It is therefore difficult to manage the remaining portion 404 of memory area 4 through a memory management unit of a processor. Also, one memory management unit cannot provide efficient control when the data transfer portion 403 of the memory area 2 exists between the remaining portions 402 and 404. Even when the remaining portions of the shared memory areas are assigned to a specific port, extended use of the remaining portions is difficult due to a discontinuous address map.

In assigning remaining portions of the shared memory areas, not including those portions designated as data transfer portions, to one port within a shared memory area to reduce waste of memory resources, an address for a data transfer is in the middle of the address map in a conventional address structure. It is thus difficult to use all of the remaining portions. Therefore, a solution to use all of the remaining portions is required.

Accordingly, embodiments of the invention provide a semiconductor memory device capable of forming a continuous address map for remaining portions of shared memory areas assigned to one port by changing an address map structure in hardware. Also, embodiments of the invention provide a multipath accessible semiconductor memory device for which a processor connected to one port can dedicatedly use remaining portions of shared memory areas.

Various embodiments of the invention provide a semiconductor memory device and a memory use extension method thereof, capable of forming a continuous address map for remaining portions of shared memory areas. Also, embodiments of the invention provide a multipath accessible semiconductor memory device having a memory use extension function, and a memory use extension method thereof.

Embodiments of the invention provide a semiconductor memory device having a row address decoder. A DRAM address map can obtain a continuous address map structure in a multipath accessible semiconductor memory device using shared memory areas of multiple memory banks. Embodiments of the invention provide a method of reducing or substantially eliminating unused memory areas in assigning shared memory areas dedicatedly to one port to get a memory use extension. Embodiments of the invention also provide an improved semiconductor memory device and corresponding method, capable of using remaining portions, other than data transfer portions in shared memory areas, dedicated to a specific processor, without wasting resources.

According to an embodiment of the invention, a semiconductor memory device for use in a multiprocessor system includes at least two shared memory areas and a row decoder. The shared memory areas are accessible in common by multiple processors of the multiprocessor system through different ports, and assigned based on predetermined memory capacity to a portion of a memory cell array. The row decoder is configured to form a continuous address map for remaining memory portions of the shared memory areas to be dedicated to one port. Each remaining memory portion does not include a corresponding data transfer portion within each shared memory area.

Each data transfer portion may be accessible in common by the processors, and each remaining memory portion may accessible exclusively by one of the processors.

The row decoder may obtain for the shared memory areas a comprehensive address map. The address map may include, in sequence, a first assignment address for a first data transfer portion, a first assignment address dedicated to one port, a second assignment address dedicated to the one port, and a second assignment address for a second data transfer portion, in response to a row address applied to drive a row of the shared memory areas.

A first data transfer portion of a first shared memory area may be assigned to a least significant address, and a second data transfer portion of a second shared memory area may be assigned to a most significant address. Alternatively, a first data transfer portion of a first shared memory area may be assigned to a most significant address, and a second data transfer portion of a second shared memory area may be assigned to a least significant address.

When an address to access each corresponding data transfer portion is applied, the data transfer portion may be disabled and an interface register may be enabled. The interface register may be positioned outside the memory cell array to provide a data interface function among the processors. The interface register may include a latch type data storage circuit.

The memory cell array may also include at least one dedicated memory area accessible by only one of the processors. Also, the predetermined memory capacity may be a memory bank unit.

According to another embodiment of the invention, a semiconductor memory device for use in a multiprocessor system includes first and second shared memory areas accessible in common by multiple processors of the multiprocessor system through different ports, and assigned by unit of predetermined memory capacity to a portion of a memory cell array. The semiconductor memory device further includes a row decoding unit having first and second row decoders for extending memory use of one port. The first row decoder is configured to perform a row address decoding in sequence from a first data transfer portion of the first shared memory area to a first remaining memory portion of the first shared memory area, so as to access the first data transfer portion of the first shared memory area by a least significant row address. The second row decoder is configured to perform a reverse row address decoding from a second remaining memory portion of the second shared memory area to a second data transfer portion of the second shared memory area, so as to access the second data transfer portion of the second shared memory area by a most significant row address.

According to another embodiment of the invention, a multiprocessor system includes at least two processors, each performing a predetermined task; a nonvolatile semiconductor memory connected to one of the processors, for storing boot code of the at least two processors; and a semiconductor memory device. The semiconductor memory device includes at least two shared memory areas, accessible in common by the at least two processors through different ports and assigned by unit of predetermined memory capacity to a portion of a memory cell array, and a row decoder configured to form a continuous address map for remaining memory portions of the shared memory areas to be assigned to one determined port. The remaining memory portions exclude corresponding data transfer portions within the shared memory areas. The nonvolatile semiconductor memory device may include a NAND flash memory, and the system may be a portable multimedia device, for example.

According to another embodiment of the invention, a row decoding method is provided for use in a semiconductor memory device including at least two shared memory areas accessible in common by processors of a multiprocessor system through different ports and assigned by predetermined memory capacity to a portion of a memory cell array. The method includes receiving a row address and performing a row decoding operation in response to the row address to form a continuous address map for remaining memory portions to be assigned exclusively to one determined port for a memory use extension of the one port. The remaining memory portions do not include corresponding data transfer portions within the shared memory areas.

The row decoding operation may be performed in sequence from a word line near a row decoder in one shared memory area. Also, the row decoding operation may be performed in sequence from a word line near a corresponding row decoder in a shared memory area adjacent to the one shared memory area.

Accordingly, a continuous address map is provided for remaining memory areas within shared memory areas, thus reducing or substantially eliminating unused areas of shared memory areas. Further, controlling a memory management unit for shared memory areas may be efficiently performed, thereby obtaining memory density extension, without wasting memory resources.

### BRIEF DESCRIPTION OF THE DRAWINGS

The embodiments of the present invention will be described with reference to the attached drawings, which are given by way of illustration only and thus are not limiting of the present invention, wherein:

FIG. 1 is a block diagram illustrating a conventional multiprocessor system;

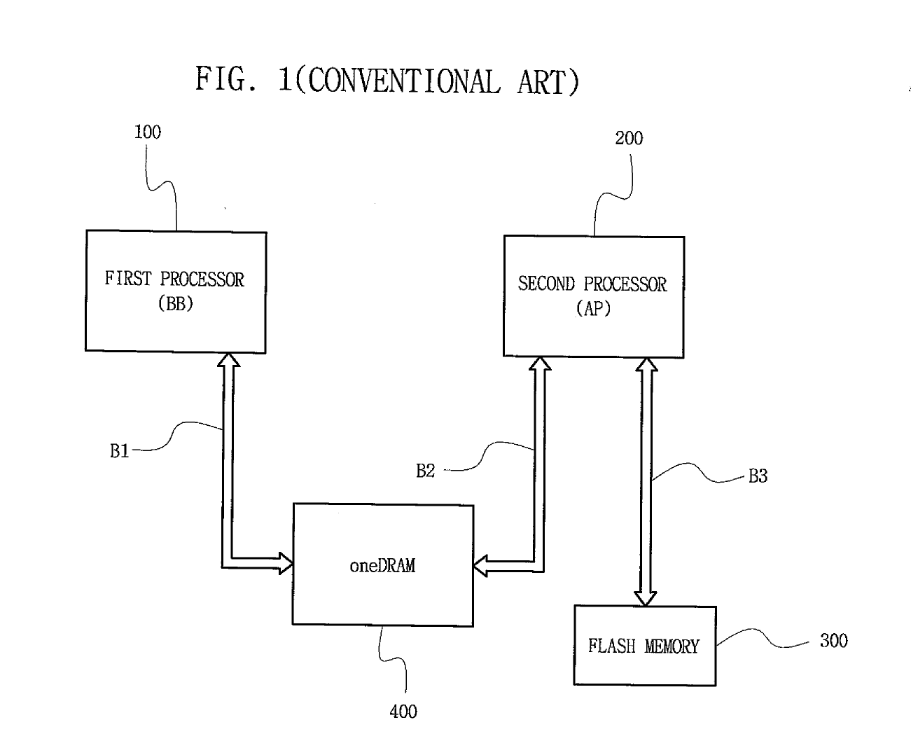

FIG. 2 is a block diagram illustrating a conventional DRAM, as shown in FIG. 1;

FIG. 3 illustrates conventional address assignments to access memory banks and a register of FIG. 2;

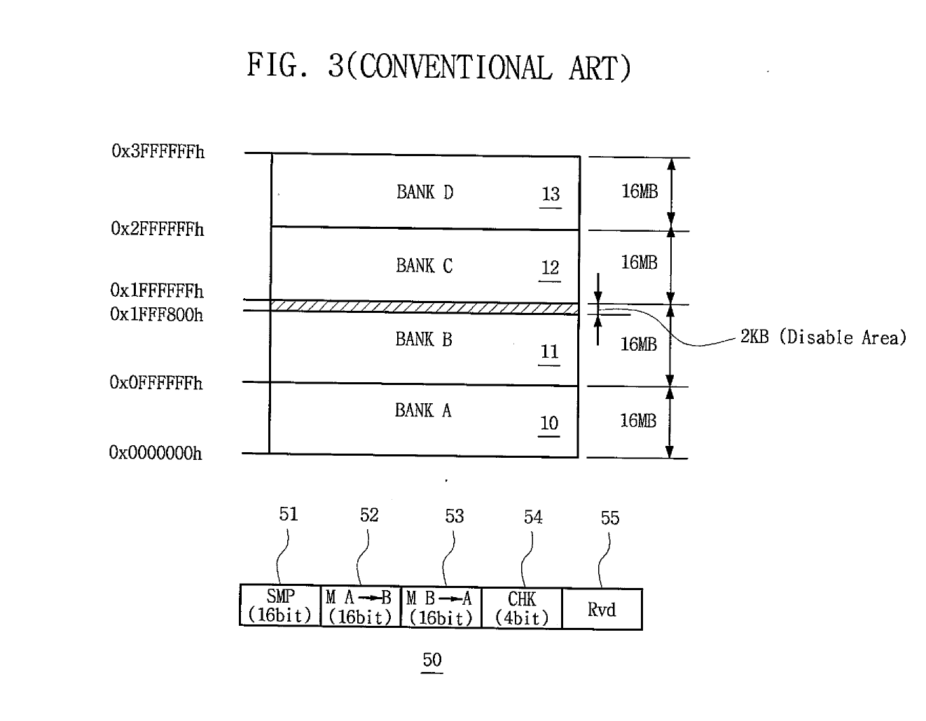

FIG. 4 illustrates conventional limitations in a memory use extension for one port in a shared memory bank structure;

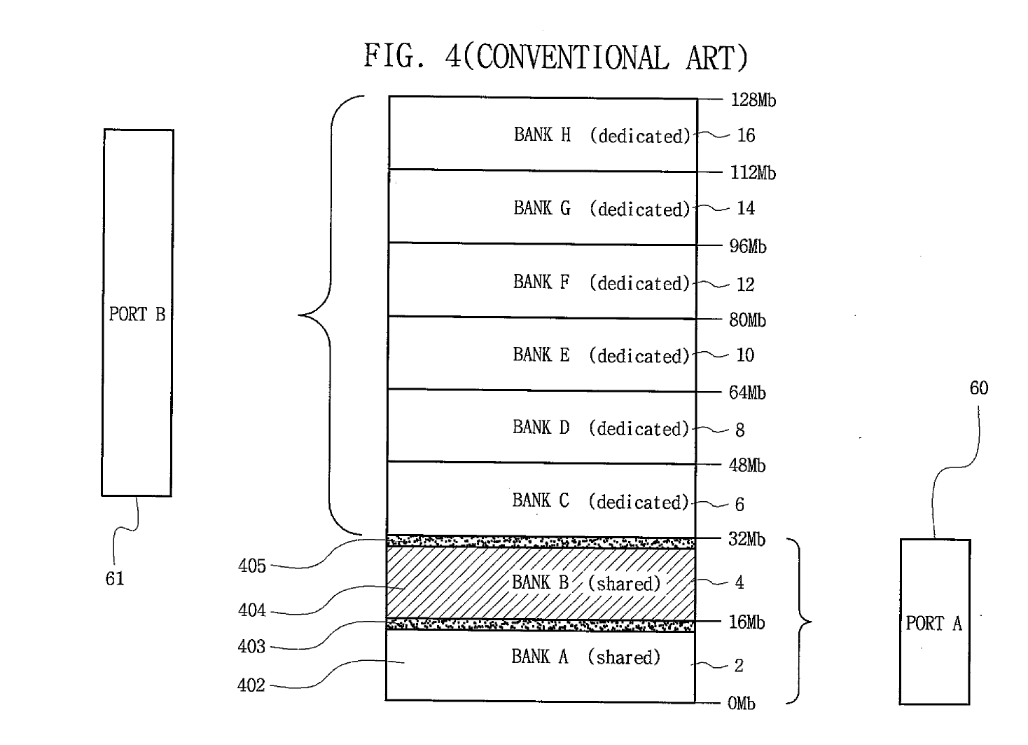

FIG. 5 is block diagram of shared memory areas and corresponding row decoders for a memory use extension, according to an embodiment of the invention;

FIG. 6 illustrates a memory use extension for one port referred to in FIG. 5, according to an embodiment of the invention;

FIG. 7 is a block diagram of a corresponding layout between dedicated and shared memory banks and row decoders, as shown in FIG. 5, according to an embodiment of the invention;

FIG. 8 is a circuit diagram illustrating a row decoder, according to an embodiment of the invention; and

FIG. 9 is a block diagram illustrating a semiconductor memory device having multipath access to a shared memory area, according to an embodiment of the invention.

### DETAILED DESCRIPTION

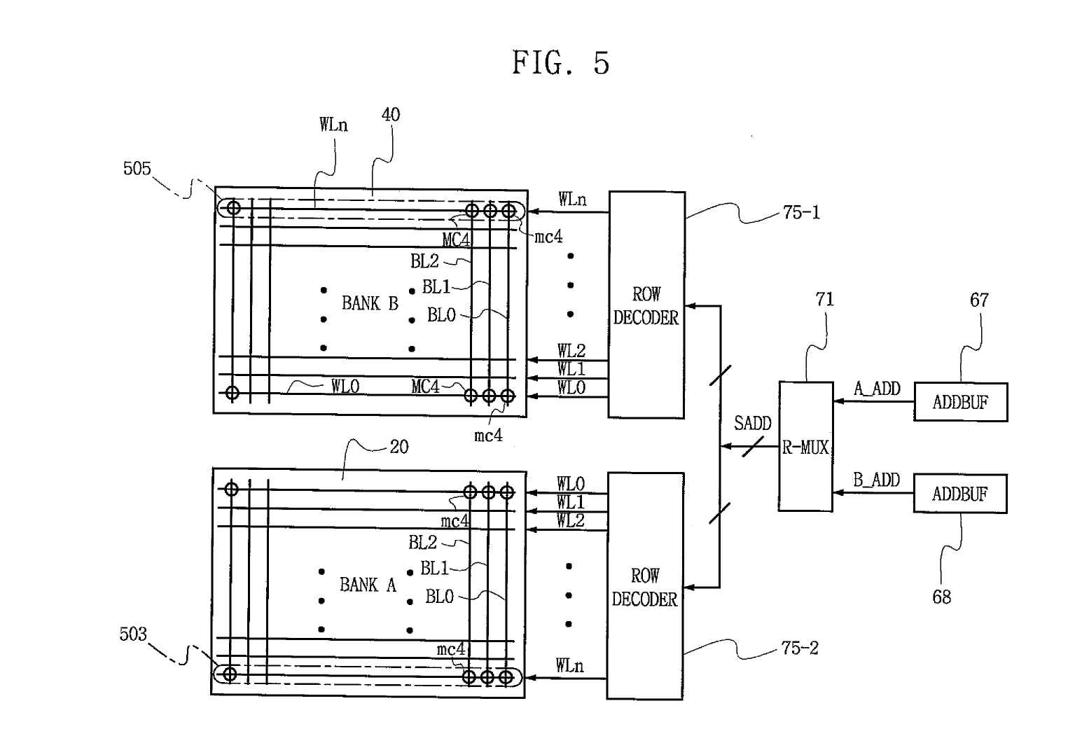

The present invention will now be described more fully with reference to FIGS. 5 to 9, in which exemplary embodiments of the invention are shown. The invention may, however, be embodied in various different forms, and should not be construed as being limited only to the illustrated embodiments. Rather, these embodiments are provided as examples, to convey the concept of the invention to one skilled in the art. Accordingly, known processes, elements, and techniques are not described with respect to some of the embodiments of the present invention. Throughout the drawings and written description, like reference numerals will be used to refer to like or similar.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein. Exemplary embodiments of the present invention are more fully described below with reference to FIGS. 5 to 9. This invention, however, may be embodied in many different forms and should not be construed as being limited to the exemplary embodiments set forth herein; rather, these exemplary embodiments are provided so that this disclosure is thorough and complete, and conveys the concept of the invention to those skilled in the art. For purposes of clarity, a detailed description for other examples, publication methods, procedures, general dynamic random access memories and circuits as known functions and systems are not specifically described.

A multipath accessible semiconductor memory device having a memory use extension function and a use extension method therefor are described with reference to the accompanied drawings, as follows.

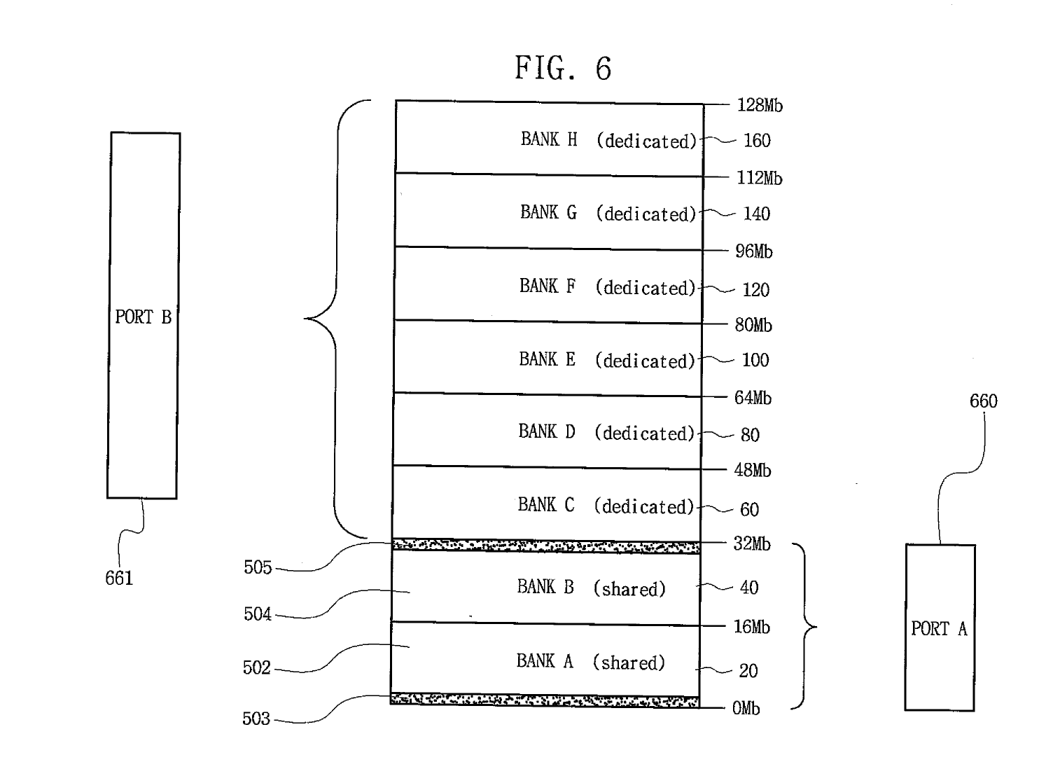

According to an embodiment of the invention, a data transfer portion 503, referred to in FIGS. 5 and 6, is assigned a least significant address of a memory area 20 (bank A) to obtain continuity of the address map. Accordingly, the address map for the respective remaining portions of the memory area 20 (bank A) and memory area 40 (bank B) are continuous and dedicated use of the memory areas by one optional processor can be extended.

FIG. 5 is a block diagram for providing row decoding for a memory use extension on one port in a multi-shared memory bank structure, according to an embodiment of the invention.

Referring to FIG. 5, a row address multiplexer 71 selects one of output address A_ADD of an address buffer 67 of port A and output address B_ADD of an address buffer 68 of port B. The row address multiplexer 71 outputs the selected address as selection row address SADD. A second row decoder 75-2, connected to corresponding memory area 20 (bank A), performs a decoding operation opposite to that of a first row decoder 75-1, connected to corresponding memory area 40 (bank B), in response to the selection row address SADD.

When memory area 40 (bank B) is enabled, the first row decoder 75-1 performs a typical row decoding operation. In other words, when a least significant row address is applied, the first row decoder 75-1 enables a lowest word line of bank B as the first word line WL0. When a higher row address (e.g., increased by 1) is applied, the first row decoder 75-1 enables a next consecutive higher word line of bank B as second word line WL1.

When memory area 20 (bank A) is enabled, the second row decoder 75-2 performs a row decoding operation opposite to that of the first row decoder 75-1. That is, when a least significant row address is applied, the second row decoder 75-2 enables a highest word line of bank A as the first word line WL0. Further, when a higher row address (e.g., increased by 1) is applied, the second row decoder 75-2 enables a next consecutive lower word line of bank A as second word line WL1.

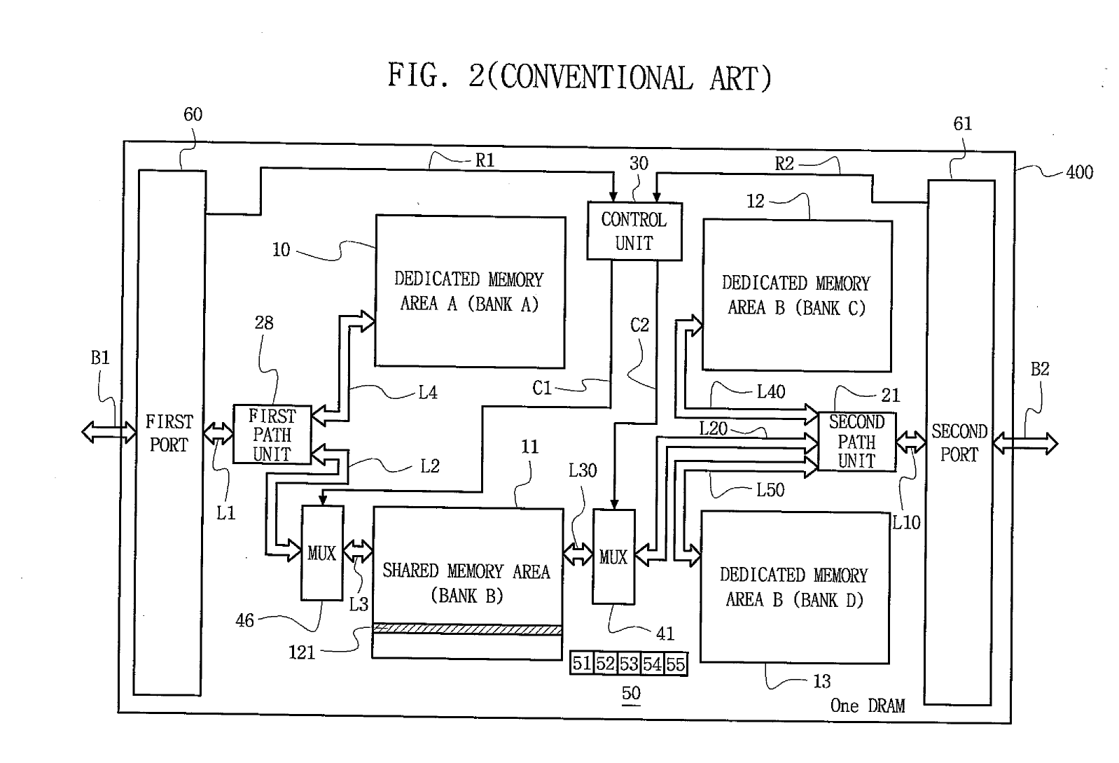

Also, a data transfer portion 503 of the memory area 20 (bank A) and a data transfer portion 505 of the memory area 40 (bank B) shown in FIG. 5 may correspond to specific row area 121 of FIG. 2, for example, which is not actually enabled. Rather, register 50 may be enabled instead.

Consequently, a continuous address map for the remaining memory portions of memory areas 20 and 40, e.g., remaining memory portions 502 and 504, assigned dedicatedly to one determined port, may be formed as shown in FIG. 6, by a reverse row decoding operation of the second row decoder 75-2 shown in FIG. 5. The remaining memory portions 502 and 504 are the portions of the shared memory areas 20 and 40 that do not include the data transfer portions 503 and 505, respectively.

The shared memory areas 20 and 40, as shown in FIGS. 5 and 6, are accessed in common by processors of a multiprocessor system through different ports. However, in an embodiment of the invention, portions of the memory areas 20 and 40, excluding the data transfer portions 503 and 505, may be accessed exclusively by the first processor 100, for example, through port 660 (port A).

As described above with reference to FIG. 5, a continuous address map for the remaining memory portions 502 and 504, dedicatedly assigned to one determined port, is formed by reverse row decoding performed by the second row decoder 75-2. Also, the data transfer portions 503 and 505 are accessible in common by the processors 100 and 200, and the corresponding remaining memory portions 502 and 504 are accessed exclusively by one of the processors 100 or 200.

FIG. 6 illustrates a memory use extension for one port referred to in FIG. 5. Referring to FIG. 6, an address map is formed in sequence, including a first assignment address for the data transfer portion 503, a first dedicated assignment address for the remaining portion 502, a second dedicated assignment address for the remaining portion 504, and a second assignment address for the data transfer portion 505, by the decoding operation of the row decoding unit having row decoders 75-1 and 75-2, as shown in FIG. 5. That is, when there are two adjacent shared memory areas, the data transfer portion 503 of the shared memory area 20 is assigned a least significant address, and the data transfer portion 505 of the shared memory area 4 is assigned a most significant address.

In FIG. 6, when addresses to access the data transfer portions 503 and 505 are applied, the data transfer portions 503 and 505 are disabled, and their corresponding interface register is enabled. As shown in FIG. 2, for example, the interface register 50 is outside the memory cell array to provide a data interface function between the processors, and may be a latch type data storage circuit.

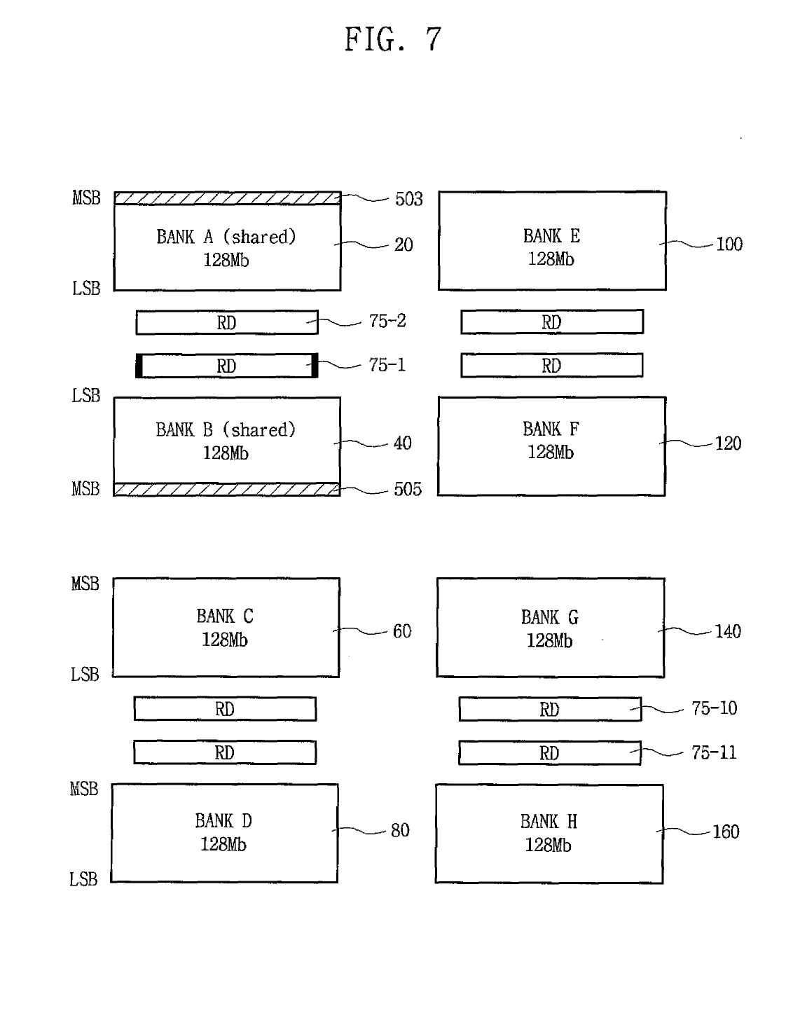

FIG. 7 shows a corresponding layout between dedicated and shared memory banks and row decoders referred to in FIG. 5. In FIG. 7, each of the eight memory areas (banks A to H) is shown as have a storage capacity of 128 Mb, and two of the memory areas are predetermined as shared memory banks (banks A and B). The rest of the memory banks are predetermined as dedicated access memory banks of the second processor 200, as shown in FIG. 6. In the layout depicted in FIG. 7, the data transfer portion 503 is assigned normally in the memory area 20 (bank A), but in the memory area 40 (bank B), the data transfer portion 505 is assigned symmetrically opposite to the data transfer portion 503 on the row decoder. In other words, the data transfer portion 505 of bank B is actually matched to a least significant row address by the reverse decoding, e.g., performed by the first row decoder 75-1.

As a result, as described above, row decoding to form a continuous address map for remaining memory portions to be assigned to one determined port is performed to obtain extended memory use for one port, according to embodiments of the invention. The remaining memory portions include the portions of the shared memory areas other than the data transfer portions within each of the shared memory areas. The row decoding for one shared memory area is performed in sequence, beginning with a word line nearest to the row decoder, as shown in FIG. 7. The row decoding for the shared memory area adjacent to the one shared memory area is likewise performed in sequence from a word line nearest to the corresponding row decoder. Thus, a continuous address map is formed, enabling control through a memory management unit.

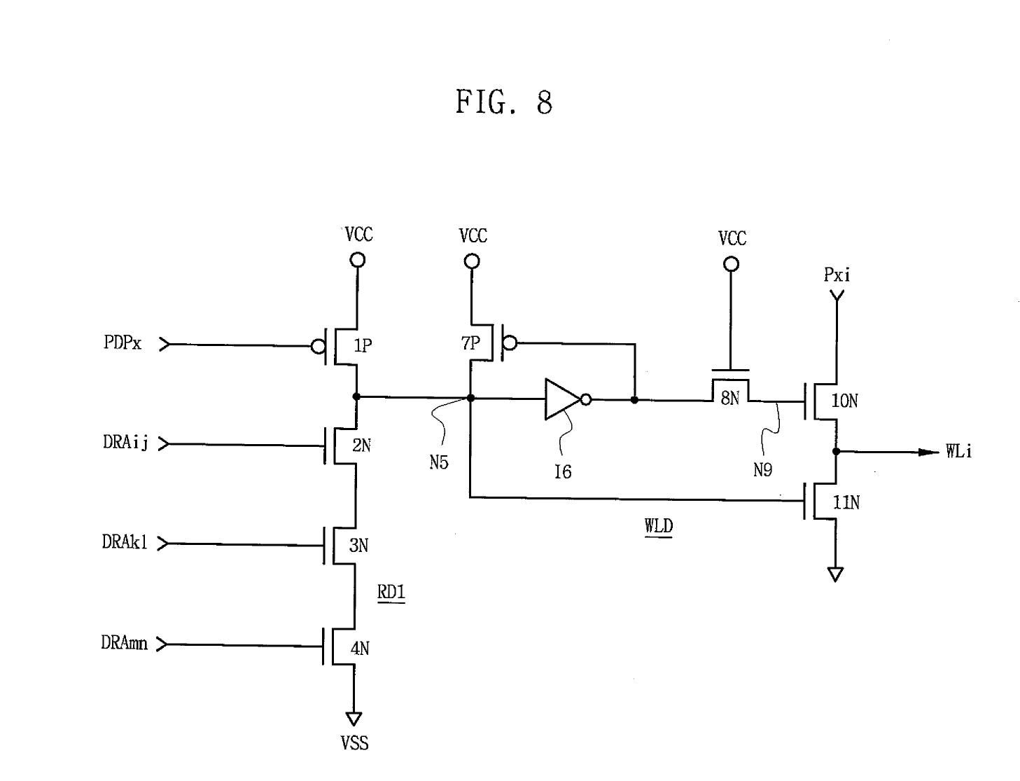

FIG. 8 is a circuit diagram illustrating in detail a row decoder, according to an embodiment of the invention. Referring to FIG. 8, the row decoder (e.g., row decoder 75-1, 75-2) includes a row decoding unit RD1 and a word line driver WLD. The row decoding unit RD1 includes a PMOS transistor 1P, and three NMOS transistors 2N, 3N and 4N, having channels coupled in series. The word line driver WLD includes a PMOS transistor 7P, an inverter 16 and NMOS transistors 8N, 10N and 11N. The row decoding unit RD1 and the word line driver WLD are collectively referred to as a row decoder, for purposes of explanation.

A typical row decoder decodes row addresses and drives a selected word line to a voltage level higher than a level of a power source voltage (e.g., VCC) through a self-boosting operation.

Signals DRAij, DRAkl and DRAmn shown in FIG. 8 may be decoded-row addresses applied from a predecoder. NMOS transistors 2N, 3N and 4N, which receive the decoded row addresses through gate terminals, are individually turned on when the corresponding gate level is high. When a row address strobe signal is precharged to a level of the power source voltage VCC, the PDPx signal applied to a gate of the PMOS transistor 1P has a low state, e.g., a level of a ground voltage VSS. At this time, each of the decoded row addresses DRAij DRAkl, DRAmn enters a low state, and thus node N5 is precharged to a high state.

When the row address strobe signal is transitioned to a low level and enters an active state to obtain an access operation of given data, only a selected row decoder circuit, to which the decoded row address DRAij, DRAkl, DRAmn is input in a high state, is driven. The other row decoder circuits are kept in a precharge state. The node N5 of the selected row decoder enters a low state and node N9 is charged to a high state of power source voltage level VCC through the inverter 16. Then, when a word line signal Pxi is applied at a high level, a self-boosting operation occurs, passing through a channel of pull-up transistor 10N. Accordingly, the word line signal Pxi is applied to word line and a selected word line WLi is enabled.

In the depicted embodiment of the invention, the decoding operation of the word line decoder shown in FIG. 8 determines a bank of the shared memory areas and performs reverse decoding, e.g., as illustrated with FIG. 5. Further, it is possible to change wiring between an output line of the row decoder and a word line without the reverse decoding, or to form a continuous address map in software without changing the decoder hardware, thereby obtaining a reverse decoding effect.

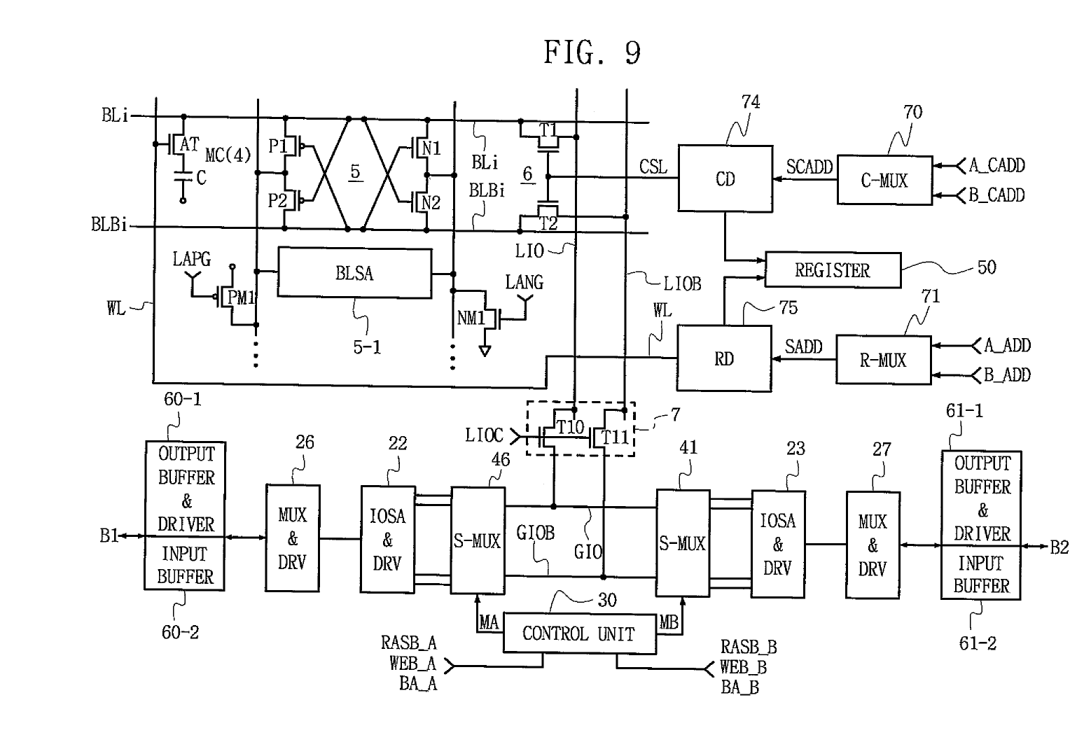

FIG. 9 is a block diagram of a semiconductor memory device illustrating multipath access to one shared memory area, according to an embodiment of the invention.

Only one shared memory area of two is shown in FIG. 9 just for a description. When the row decoder 75 is used as the first row decoder 75-1 of FIG. 5, a normal row decoding is performed. When the row decoder 75 is used as the second row decoder 75-2, a reverse row decoding is performed.

A method of connecting one shared memory area to one selected from two ports is described more in detail, with reference to FIG. 9.

In FIG. 9, an internal register 50 is located outside a memory cell array. Though not limited, the semiconductor memory device shown in FIG. 9 shows two independent ports. The internal register 50 functions as an interface unit to interface between processors, e.g., the first and second processors 100 and 200, and is accessible by the processors. The internal register 50 may be a flip-flop, a data latch or a SRAM cell, for example. Also, the internal register 50 may include a semaphore area 51, a first mailbox area 52 (e.g., mail box A to B), a second mailbox area 53 (e.g., mail box B to A), a check bit area 54, and reserve area 55.

A second multiplexer 46 corresponding to a first port (e.g., port 660) and a second multiplexer 41 corresponding to a second port (e.g., port 661) are disposed symmetrically with respect to a shared memory area (e.g., shared memory area 20, 40). Likewise, an input/output sense amplifier and driver 22 and an input/output sense amplifier and driver 23 are disposed symmetrically with respect to the shared memory area. Within the shared memory area, a DRAM cell MC(4), constructed of one access transistor AT and a storage capacitor C, forms a unit memory device. Each DRAM cell MC(4) is connected at intersections of word lines and bit lines, forming a matrix type bank array. A word line WL is located between a gate of access transistor AT of the DRAM cell MC(4) and row decoder 75. The row decoder 75 applies the row decoded signal to the word line WL and the register 50 in response to a selection row address SADD provided by row address multiplexer 71.

A bit line BLi constituting a bit line pair is coupled to a drain of the access transistor AT and a column selection transistor T1. A complementary bit line BLBi is coupled to a column selection transistor T2. PMOS transistors P1 and P2 and NMOS transistors N1 and N2 coupled to the bit line pair BLi, BLBi constitute a bit line sense amplifier 5. Sense amplifier driving transistors PM1 and NM1 receive drive signals LAPG and LANG, respectively, and drive the bit line sense amplifier 5.

A column selection gate 6 includes the column selection transistors T1 and T2 and is coupled to a column selection line CSL for transferring a column decoded signal of a column decoder 74. The column decoder 74 applies a column decoded signal to the column selection line and the register 50 in response to a selection column address SCADD of column address multiplexer 70.

In FIG. 9, a local input/output line pair LIO, LIOB is coupled to a first multiplexer F-MUX 7, which includes transistors T10 and T11. When the transistors T10 and T11 are turned on in response to a local input/output line control signal LIOC, the local input/output line pair LIO, LIOB is coupled to a global input/output line pair GIO, GIOB. Then, data of the local input/output line pair LIO, LIOB is transferred to the global input/output line pair GIO, GIOB in a read operating mode of data. Conversely, write data applied to the global input/output line pair GIO, GIOB is transferred to the local input/output line pair LIO, LIOB in a write operating mode of data. The local input/output line control signal LIOC may be a signal generated in response to a decoded signal output from the row decoder 75.

When a path decision signal MA output from a control unit 30 has an active state, read data transferred to the global input/output line pair GIO, GIOB is transferred to the input/output sense amplifier and driver 22 through the second multiplexer 46. The input/output sense amplifier and driver 22 amplifies data having a weakened level due to the data path transfer. Read data output from the input/output sense amplifier and driver 22 is transferred to the first port 660 through the multiplexer and driver 26. Meanwhile, the path decision signal MB is in an inactive state, thus the second multiplexer 41 is disabled, preventing access to the shared memory area (e.g., memory area 20, 40) by the second processor 200. However, the second processor 200 may still access dedicated memory areas (e.g., memory areas 60 to 160) through the second port 661.

When the path decision signal MA output from the control unit 30 is in the active state, write data applied through the first port 60 is transferred to the global input/output line pair GIO, GIOB, sequentially passing through the multiplexer and driver 26, the input/output sense amplifier and driver 22 and the second multiplexer 46. When the first multiplexer (F-MUX) 7 is activated, the write data is transferred to the local input/output line pair LIO, LIOB and then is stored in a selected memory cell MC(4).

An output buffer and driver 60-1 and input buffer 60-2 shown in FIG. 9 may correspond to or be included in the first port 660 of FIG. 6. Two input/output sense amplifier and drivers 22 and 23 are adapted. The two multiplexers 46 and 41 have mutually complementary operations, so as to prevent two processors from simultaneously accessing data of the shared memory area (e.g., memory areas 20, 40).

The first and second processors 100 and 200 commonly use circuit devices and lines that are adapted between global input/output line pair GIO, GIOB and memory cell MC(4) in an access operation, and separately use input/output related circuit devices and lines between respective ports and the second multiplexer 46, 41. More particularly, the global input/output line pair GIO, GIOB of the shared memory area, the local input/output line pair LIO, LIOB operationally connected to the global input/output line pair, the bit line pair BL, BLB operationally connected to the local input/output line pair through column selection signal CSL, the bit line sense amplifier 5 installed on the bit line pair BL, BLB to sense and amplify data of bit line, and the memory cell(s) MC(4) in which access transistor AT is connected to the bit line BL, are shared by the first and second processors 100 and 200 through the first and second ports 660 and 661, respectively.

As described above, in the semiconductor memory device according to the depicted embodiments having detailed exemplary configurations shown in FIG. 9, an interface function between processors 100 and 200 can be attained. The processors 100 and 200 perform data communication through the commonly accessible shared memory area using internal register 50 functioning as an interface. A precharge skip problem may also be solved in an access authority transfer.

A continuous address map for remaining memory portions of shared memory areas to be assigned to one determined port is formed by a decoding operation of row decoder to realize embodiments of the invention. The remaining memory portion does not include a data transfer portion within the shared memory area.

Although described with reference to two processors, it is understood that the various embodiments of the multiprocessor system may be applied to any number of processors. Also, it is understood that each processor of the multiprocessor system may be a microprocessor, CPU, digital signal processor, micro controller, reduced command set computer, complex command set computer, or the like.

It should be further understood that the scope of the invention is not limited to the number of processors in the system or to any particular combination of processors. For example, of the eight exemplary memory areas, three may be designated shared memory areas and the remaining five memory areas may be designated dedicated memory areas. Alternatively, four or more memory areas may be determined shared memory areas. In addition, though the system employing two processors is described above as an example, in employing three or more processors in the system, three or more ports may be provided in one DRAM, and one of the three processors may access a predetermined shared memory at a specific time. Furthermore, although DRAM is described above as an example of a semiconductor memory device, various embodiments may include other types of memories, such as static random access memories, nonvolatile memories, etc.

In the device and method according to embodiments of the invention, unused portions of shared memory areas can be reduced or eliminated through use of a continuous address map for the remaining memory portions within the shared memory areas. A memory management unit may thus efficiently control the shared memory areas, thereby obtaining a memory density extension without wasting memory resources.

It will be apparent to those skilled in the art that modifications and variations can be made without deviating from the spirit or scope of the invention. Thus, it is intended that embodiments of the present invention cover such modifications and variations. For example, details in row decoding, or configuration of a shared memory bank or circuit, and an access method may be varied diversely.

In the drawings and specification, there have been disclosed exemplary embodiments of the invention and, although specific terms are employed, they are used in a generic and descriptive sense and not for purposes of limitation. While the present invention has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A semiconductor memory device for use in a multiprocessor system, the device comprising:
at least two shared memory areas accessible in common by a plurality of processors of the multiprocessor system through different ports, and assigned based on predetermined memory capacity to a portion of a memory cell array; and
a row decoder configured to form a continuous address map for remaining memory portions of the at least two shared memory areas to be dedicated to one port, each remaining memory portion excluding a corresponding data transfer portion within each shared memory area.

2. The device of claim 1, wherein each data transfer portion is accessible in common by the plurality of processors, and each remaining memory portion is accessible exclusively by one of the processors.

3. The device of claim 1, wherein the row decoder obtains for the shared memory areas a comprehensive address map comprising, in sequence, a first assignment address for a first data transfer portion, a first assignment address dedicated to one port, a second assignment address dedicated to the one port, and a second assignment address for a second data transfer portion, in response to a row address applied to drive a row of the shared memory areas.

4. The device of claim 1, wherein a first data transfer portion of a first shared memory area is assigned to a least significant address, and a second data transfer portion of a second shared memory area is assigned to a most significant address.

5. The device of claim 1, wherein a first data transfer portion of a first shared memory area is assigned to a most significant address, and a second data transfer portion of a second shared memory area is assigned to a least significant address.

6. The device of claim 1, wherein when an address to access each corresponding data transfer portion is applied, the data transfer portion is disabled and an interface register is enabled.

7. The device of claim 6, wherein the interface register is positioned outside the memory cell array to provide a data interface function among the plurality of processors, the interface register comprising a latch type data storage circuit.

8. The device of claim 1, wherein the memory cell array further comprises at least one dedicated memory area accessible by only one of the plurality of processors.

9. The device of claim 1, wherein the predetermined memory capacity comprises memory bank unit.

10. A semiconductor memory device for use in a multiprocessor system, the device comprising:
first and second shared memory areas accessible in common by a plurality of processors of the multiprocessor system through different ports, and assigned by unit of predetermined memory capacity to a portion of a memory cell array; and
a row decoding unit comprising first and second row decoders for extending memory use of one port, the first row decoder being configured to perform a row address decoding in sequence from a first data transfer portion of the first shared memory area to a first remaining memory portion of the first shared memory area, so as to access the first data transfer portion of the first shared memory area by a least significant row address, and the second row decoder being configured to perform a reverse row address decoding from a second remaining memory portion of the second shared memory area to a second data transfer portion of the second shared memory area, so as to access the second data transfer portion of the second shared memory area by a most significant row address.

11. The device of claim 10, wherein the first and second data transfer portions are accessed in common by the plurality of processors, and the first and second remaining memory areas are accessed dedicatedly by one of the plurality of processors for the memory use extension.

12. The device of claim 11, wherein the row decoding unit is configured to obtain an address map comprising, in sequence, a second assignment address for the second data transfer portion, a second assignment address dedicated to the one port, a first assignment address dedicated to the one port, and a first assignment address for the first data transfer portion, in response to a row address applied to drive a row of the first and second shared memory areas.

13. The device of claim 11, wherein when an addresses to access the first or second data transfer portion is applied, the corresponding first or second data transfer portion is disabled and a corresponding interface register is enabled.

14. The device of claim 13, wherein the interface register is positioned outside the memory cell array to provide a data interface function among the plurality of processors, the interface register comprising a data storage circuit of a latch type.

15. The device of claim 10, wherein the memory cell array further comprises at least one dedicated memory area exclusively accessible by one processor.

16. The device of claim 10, wherein the unit of predetermined memory capacity comprises a unit of memory bank.

17. A multiprocessor system comprising:
at least two processors, each performing a predetermined task;
a nonvolatile semiconductor memory connected to one of the processors, for storing boot code of the at least two processors; and
a semiconductor memory device comprising at least two shared memory areas, accessible in common by the at least two processors through different ports and assigned by unit of predetermined memory capacity to a portion of a memory cell array, and a row decoder configured to form a continuous address map for remaining memory portions of the shared memory areas to be assigned to one determined port, the remaining memory portions excluding corresponding data transfer portions within the shared memory areas.

18. The system of claim 17, wherein the nonvolatile semiconductor memory device comprises a NAND flash memory.

19. The system of claim 18, wherein the system is a portable multimedia device.

20. A row decoding method for use in a semiconductor memory device including at least two shared memory areas accessible in common by processors of a multiprocessor system through different ports and assigned by predetermined memory capacity to a portion of a memory cell array, the method comprising:
receiving a row address; and
performing a row decoding operation in response to the row address to form a continuous address map for remaining memory portions to be assigned exclusively to one determined port for a memory use extension of the one port, the remaining memory portions not including corresponding data transfer portions within the shared memory areas.

21. The method of claim 20, wherein when the row decoding operation is performed in sequence from a word line near a row decoder in one shared memory area, the row decoding operation is performed in sequence from a word line near a corresponding row decoder in a shared memory area adjacent to the one shared memory area.
